(19) United States
(12) Patent Application Publication
(10) Pub. No.: US 2023/0136039 A1
(43) Pub. Date: May 4, 2023

(54) RESOURCE ALLOCATION METHOD AND RESOURCE ALLOCATION SYSTEM

(71) Applicant: INSTITUTE FOR INFORMATION INDUSTRY, TAIPEI CITY (TW)

(72) Inventors: LI-SHENG CHEN, TAIPEI CITY (TW); CHENG-CHANG CHEN, TAIPEI CITY (TW); CHAO-YUAN CHIANG, TAIPEI CITY (TW)

(21) Appl. No.: 17/534,365

(22) Filed: Nov. 23, 2021

(30) Foreign Application Priority Data
Oct. 28, 2021 (TW) 110139981

(51) Int. Cl. H04W 72/08; H04W 72/06; H04W 72/04

(52) U.S. Cl. CPC H04W 72/087; H04W 72/06; H04W 72/042; H04W 72/0453; H04W 72/085

(57) ABSTRACT

A resource allocation method and a resource allocation system are provided. The resource allocation method includes the following steps. Quality parameters of each of a plurality of resource blocks are obtained through measurement devices, and first and second application scenario suitability indices for each of the resource blocks are calculated according to the quality parameters. A first ranking sequence and a second ranking sequence of the resource blocks are generated according to the first application scenario suitability index and the second application scenario suitability of each resource block. A base station is configured to allocate, according to the first ranking sequence and the second ranking sequence, at least one first resource block and at least one second resource block of the resource blocks to at least one first user equipment in a first application scenario and at least one second user equipment in a second application scenario, respectively.

### CROSS-REFERENCE TO RELATED PATENT APPLICATION

This application claims the benefit of priority to Taiwan Patent Application No. 110139981, filed on Oct. 28, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resource allocation method and a resource allocation system, and more particularly to a resource allocation method and a resource allocation system that can enable a base station to allocate appropriate resource blocks (RB) to a user equipment in different application scenarios.

### BACKGROUND OF THE DISCLOSURE

In order to meet different transmission requirements, a new generation mobile communication system proposes a variety of application scenarios. For example, the application scenarios of a fifth-generation mobile communication system include an enhanced mobile broadband (eMBB) and ultra-reliable and low latency communications (uRLLC).

The eMBB is used to meet a transmission need for high speed and high capacity, and the uRLLC is used to meet a transmission need for high reliability and low time delay. Therefore, a base station needs to be able to allocate different resource blocks to a user equipment in different application scenarios. An inappropriate allocation of the resource blocks can result in a high transmission error rate or waste of valuable wireless resources.

### SUMMARY OF THE DISCLOSURE

In response to the above-referenced technical inadequacies, the present disclosure provides a resource allocation method and a resource allocation system that can enable a base station to allocate appropriate resource blocks (RB) to a user equipment in different application scenarios.

In one aspect, one embodiment of the present disclosure provides a resource allocation method, which is applicable to a base station. The base station is configured to allocate a plurality of resource blocks to at least one first user equipment in a first application scenario and at least one second user equipment in a second application scenario. The resource allocation method includes following steps. A plurality of quality parameters of each of the plurality of resource blocks are obtained through a plurality of measurement devices, and a first application scenario suitability index and a second application scenario suitability index for each of the plurality of resource blocks are calculated according to the quality parameters. A first ranking sequence of the plurality of the resource blocks is generated according to the first application scenario suitability index of each of the plurality of resource blocks, and a second ranking sequence of the plurality of the resource blocks is generated according to the second application scenario suitability index of each of the plurality of resource blocks. The base station is configured to allocate, according to the first ranking sequence and the second ranking sequence, at least one first resource block and at least one second resource block of the resource blocks to the at least one first user equipment in the first application scenario and the at least one second user equipment in the second application scenario, respectively.

In another aspect, one embodiment of the present disclosure provides a resource allocation system, which includes a base station, a plurality of measurement devices, and a processing device. The base station is configured to allocate a plurality of resource blocks to at least one first user equipment in a first application scenario and at least one second user equipment in a second application scenario. The plurality of measurement devices are configured to measure a plurality of quality parameters of each of the plurality of resource blocks. The processing device is coupled to the base station and the plurality of measurement devices, and is configured to perform following steps. The plurality of quality parameters of each of the plurality of resource blocks are obtained through the plurality of measurement devices, and a first application scenario suitability index and a second application scenario suitability index for each of the plurality of resource blocks are calculated according to the quality parameters. A first ranking sequence of the plurality of the resource blocks is generated according to the first application scenario suitability index of each of the plurality of resource blocks, and a second ranking sequence of the plurality of the resource blocks is generated according to the second application scenario suitability index of each of the plurality of resource blocks. The base station is configured to allocate, according to the first ranking sequence and the second ranking sequence, at least one first resource block and at least one second resource block of the resource blocks to the at least one first user equipment of the first application scenario and the at least one second user equipment of the second application scenario, respectively.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a resource allocation system according to one embodiment of the present disclosure;

FIG. 2 is a flowchart of a resource allocation method according to one embodiment of the present disclosure;

FIG. 3 is a schematic diagram of resource blocks according to one embodiment of the present disclosure;

FIG. 4 is a schematic diagram of a first ranking sequence of the resource blocks according to one embodiment of the present disclosure;

FIG. 5 is a schematic diagram of a second ranking sequence of the resource blocks according to one embodiment of the present disclosure; and

FIG. 6 is a schematic diagram showing the resource blocks being allocated to at least one first user equipment in a first application scenario and at least one second user equipment in a second application scenario through a base station according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

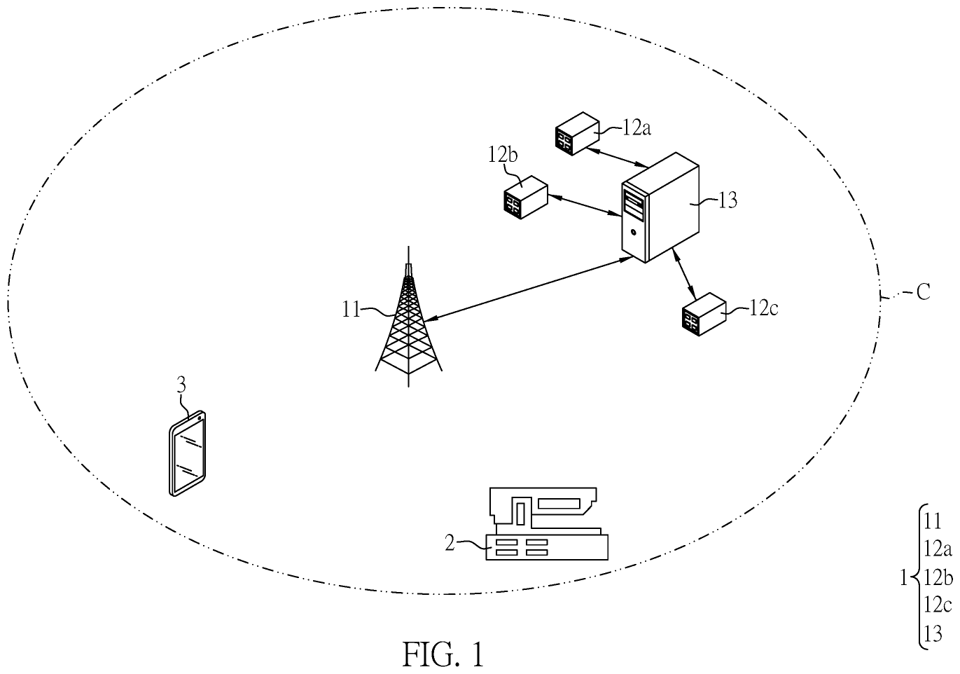

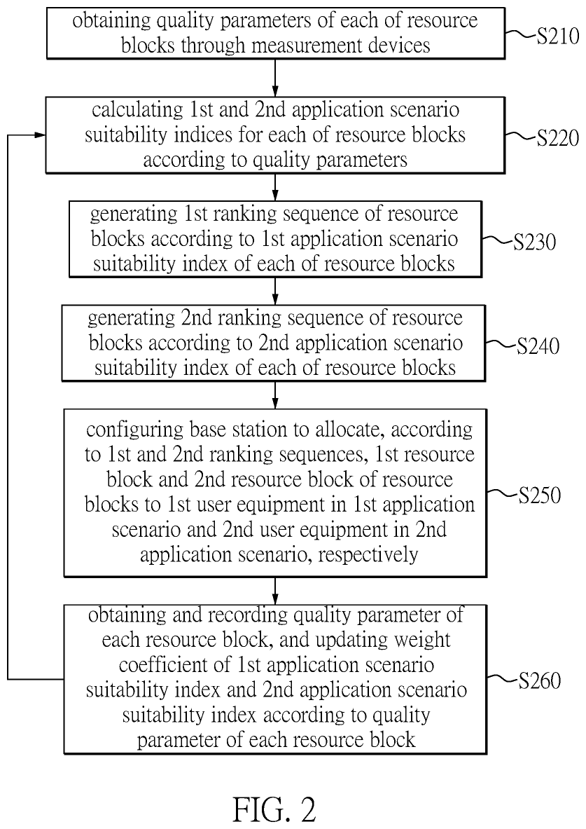

Reference is made to FIGS. 1 and 2, in which FIG. 1 is a schematic diagram of a resource allocation system according to one embodiment of the present disclosure, and FIG. 2 is a flowchart of a resource allocation method according to one embodiment of the present disclosure. As shown in FIG. 1, a resource allocation system 1 includes a base station 11, a plurality of measurement devices 12a to 12c, and a processing device 13. The base station 11 has a signal coverage range C, and at least one first user equipment in a first application scenario and at least one second user equipment in a second application scenario can be located in the signal coverage range C. However, a quantity of the first user equipment in the first application scenario and a quantity of the second user equipment in the second application scenario are not limited in the present disclosure. FIG. 1 merely illustrates a first user equipment 2 in the first application scenario and a second user equipment 3 in the second application scenario.

In addition, the first application scenario and the second application scenario of the present embodiment can respectively be, for example, uRLLC and an eMBB of a fifth-generation mobile communication system, but the present disclosure is not limited thereto. All in all, the first application scenario is used to meet a transmission need of a high reliability and a low time delay, and the second application scenario is used to meet a transmission need of a high speed and a high capacity. Therefore, under these conditions, the first user equipment 2 in the first application scenario can be, for example, an industrial control machine, and the second user equipment 3 in the second application scenario can be, for example, a smart phone, but the present disclosure is not limited thereto.

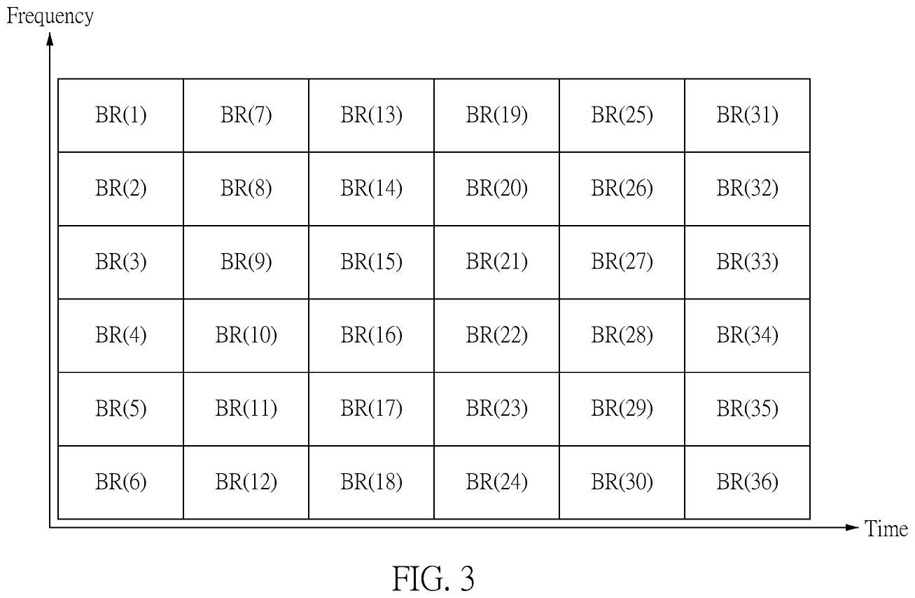

Reference is made to FIG. 3, which is a schematic diagram of resource blocks according to one embodiment of the present disclosure. As shown in FIG. 3, a frame of a new generation mobile communication system can be divided into a plurality of resource blocks in a time domain and a frequency domain. Further, one resource block is used as the smallest unit for radio resources that are allocated to a user equipment by the base station 11. Therefore, the plurality of resource blocks respectively correspond to a plurality of different time intervals or a plurality of different frequency bands, and the base station 11 is configured to allocate the plurality of resource blocks to the at least one first user equipment in the first application scenario and the at least one second user equipment in the second application scenario.

For the convenience of the following description, the present embodiment merely takes thirty-six resource blocks BR(1) to BR(36) as an example. However, a quantity of the resource blocks divided by the frame of a current mobile communication system is not limited in the present disclosure. It should be noted that each resource block has different transmission capabilities in response to different time intervals or frequency bands. Therefore, an inappropriate allocation of the resource blocks can result in a high transmission error rate or waste of valuable wireless resources.

In order to solve the above issues, the measurement devices 12a to 12c in FIG. 1 are used to measure a plurality of quality parameters of each of the plurality of resource blocks. Similarly, the present embodiment merely takes the three measurement devices 12a to 12c as an example. However, a quantity of measurement devices in the resource allocation system 1 is not limited in the present disclosure. In addition, the processing device 13 is coupled to the base station 11 and the measurement devices 12a to 12c. The processing device 13 can be a self-organizing network (SON) server, a radio intelligent controller (RIC), a processor of the base station 11, or other specific machines or equipment, and is used to execute steps in FIG. 2.

More specifically, the resource allocation method of FIG. 2 is applicable to the base station 11, and can be executed by the self-organizing network server, the radio intelligent controller, the processor of the base station 11, or other specific machines or equipment. However, a specific implementation of the specific machines or equipment is not limited in the present disclosure. As shown in FIG. 2, in step S210, the processing device 13 obtains the quality parameters of each of the plurality of resource blocks through the measurement devices 12a to 12c. Further, in step S220, the processing device 13 calculates a first application scenario suitability index and a second application scenario suitability index for each of the plurality of resource blocks according to the quality parameters.

Next, in step S230, the processing device 13 generates a first ranking sequence of the resource blocks BR(1) to BR(36) according to the first application scenario suitability index of each of the resource blocks. In step S240, the processing device 13 generates a second ranking sequence of the resource blocks BR(1) to BR(36) according to the second application scenario suitability index of each of the resource blocks. In step S250, the processing device 13 configures the base station 11 to allocate, according to the first ranking sequence and the second ranking sequence, at least one first resource block and at least one second resource block of the resource blocks BR(1) to BR(36) to the at least one first user equipment in the first application scenario and the at least one second user equipment in the second application scenario, respectively.

In the present embodiment, the plurality of quality parameters of each of the plurality of resource blocks can include a received power, an interference index, and an error rate. The error rate of each of the plurality of resource blocks is a downlink error rate at which each of the plurality of resource blocks is pre-allocated to a connection between the user equipment and the base station 11. Therefore, in this case, the measurement devices 12a to 12c can respectively be, for example, a reference signal received power (RSRP) measurement device 12a, a received signal strength indication (RSSI) measurement device 12b, and a bit error rate (BER) measurement device 12c, but the present disclosure is not limited thereto.

In more detail, the processing device 13 can obtain an RSRP of each resource block as the received power of each resource block through the RSRP measurement device 12a. Through the BER measurement device 12c, the processing device 13 can obtain a BER that is pre-allocated to the connection between the user equipment and the base station 11 by each resource block as the error rate of each resource block. Furthermore, the processing device 13 can obtain an RSSI of each of the plurality of resource blocks by using the RSSI measurement device 12b, and divide the RSSI of each of the plurality of resource blocks by the RSRP of each of the plurality of resource blocks to obtain the interference index of each of the plurality of resource blocks, but the present disclosure is not limited thereto. All in all, according to the received power, the interference index and the error rate of each resource block, the first application scenario suitability index of each resource block is expressed by the following equation:

$$ω ( i ) = {α}_{1} ⨯ {P}_{rp} ( i ) + {β}_{1} ⨯ \frac{1}{{P}_{inter} ( i )} + {γ}_{1} ⨯ \frac{1}{ER ( i )} .$$

Here, ω(i) is the first application scenario suitability index of an i-th resource block BR(i) of the resource blocks BR(1) to BR(36). In addition, Pᵣₚ(i) is the received power of the i-th resource block BR(i), Pᵢₙₜₑᵣ(i) is the interference index of the i-th resource block BR(i), ER(i) is the error rate of the i-th resource block, and α₁, β₁ and γ₁ are a first weight coefficient, a second weight coefficient and a third weight coefficient that Pᵣₚ(i), 1/Pᵢₙₜₑᵣ(i) and 1/ER(i) occupy in ω(i). In other words, α₁, β₁ and γ₁ respectively indicate importance of Pᵣₚ(i), 1/Pᵢₙₜₑᵣ(i) and 1/ER(i) in ω(i). Therefore, in order to enable ω(i) to reflect the reliability and the time delay to a greater extent, α₁, β₁ and γ₁ can be added to a predetermined constant (for example, 1), and β₁ and γ₁ are greater than α₁.

It can be observed that the higher ω(i) is, the more suitable the i-th resource block BR(i) is to be allocated to the at least one first user equipment in the first application scenario. Therefore, the processing device 13 can generate, according to the first application scenario suitability index of each resource block, the first ranking sequence in which the resource blocks BR(1) to BR(36) are suitable to be allocated to the at least one first user equipment in the first application scenario. That is to say, the first ranking sequence is generated by ranking the resource blocks BR(1) to BR(36) according to the first application scenario suitability index of each of the plurality of resource blocks from high to low.

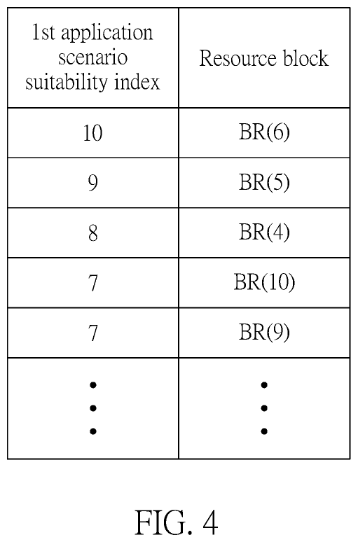

Referring to FIG. 4, FIG. 4 is a schematic diagram of a first ranking sequence of resource blocks according to one embodiment of the present disclosure. As shown in FIG. 4, in order to facilitate a comparison of the first application scenario suitability index of each resource block, the processing device 13 can further normalize the first application scenario suitability index of each resource block to an integer between 1 and 10, but the present disclosure is not limited thereto.

In contrast, according to the received power, the interference index, and the error rate of each resource block, the second application suitability index of each resource block is expressed by the following equation:

$$ε ( i ) = {α}_{2} ⨯ {P}_{rp} ( i ) + {β}_{2} ⨯ \frac{1}{{P}_{inter} ( i )} + {γ}_{2} ⨯ \frac{1}{ER ( i )} .$$

Here, ε(i) is the second application scenario suitability index of the i-th resource block BR(i) of the plurality of resource blocks, and α₂, β₂ and γ₂ are a fourth weight coefficient, a fifth weight coefficient and a sixth weight coefficient that Pᵣₚ(i), 1/Pᵢₙₜₑᵣ(i) and 1/ER(i) occupy in ε(i). Therefore, unlike ω(i), in order to enable ε(i) to reflect the speed and the capacity to a greater extent, α₂, β₂ and γ₂ can be added to the aforementioned predetermined constant (for example, 1), and α₂ is greater than β₂ and γ₂.

It can be observed that the higher ε(i) is, the more suitable the i-th resource block BR(i) is to be allocated to the at least one second user equipment in the second application scenario. Therefore, the processing device 13 can generate, according to the second application scenario suitability index of each resource block, the second ranking sequence in which the resource blocks BR(1) to BR(36) are suitable to be allocated to the at least one second user equipment in the second application scenario. That is to say, the second ranking sequence is generated by ranking the resource blocks BR(1) to BR(36) according to the second application scenario suitability index of each of the plurality of resource blocks from high to low.

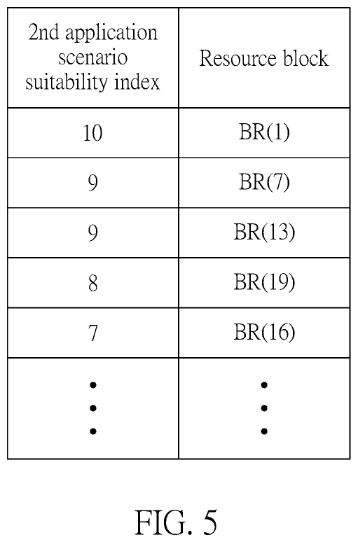

Referring to FIG. 5, FIG. 5 is a schematic diagram of a second ranking sequence of resource blocks according to one embodiment of the present disclosure. Similarly, as shown in FIG. 5, the processing device 13 can further normalize the second application scenario suitability index of each resource block to an integer between 1 and 10, so as to facilitate a comparison of the second application scenario suitability index of each resource block, but the present disclosure is not limited thereto.

The processing device 13 can then configure the base station 11 to allocate, according to the first ranking sequence of FIG. 4 and the second ranking sequence of FIG. 5, at least one first resource block and at least one second resource block of the resource blocks BR(1) to BR(36) to the at least one first user equipment in the first application scenario and the at least one second user equipment in the second application scenario, respectively.

In more detail, for any one of the resource blocks BR(1) to BR(36), such as the i-th resource block BR(i), the base station 11 can execute a matching algorithm to compare a ranking of the resource block BR(i) in the first ranking sequence with a ranking of the resource block BR(i) in the second ranking sequence. Accordingly, whether the resource block BR(i) is the first resource block allocated to the at least one first user equipment in the first application scenario or the second resource block allocated to the at least one second user equipment in the second application scenario can be determined. For example, when the i-th resource block BR(i) is ranked higher in the first ranking sequence than in the second ranking sequence, the base station 11 can determine that the i-th resource block BR(i) is the first resource block allocated to the at least one first user equipment in the first application scenario. In contrast, when the i-th resource block BR(i) is ranked higher in the second ranking sequence than in the first ranking sequence, the base station 11 can determine that the i-th resource block BR(i) is the second resource block allocated to the at least one second user equipment in the second application scenario.

In addition, for the user equipment with a large data volume, the base station 11 needs to allocate more than one resource block to the user equipment. Moreover, under regulations of the new generation mobile communication system, some resource blocks may also be preset to specific purposes, or may be prohibited from being allocated to the user equipment. Therefore, the base station 11 can also execute another matching algorithm to allocate, according to an actual data volume requirement of the user equipment and current regulations, the at least one first resource block and the at least one second resource block of the resource blocks BR(1) to BR(36) to the at least one first user equipment in the first application scenario and the at least one second user equipment in the second application scenario, respectively.

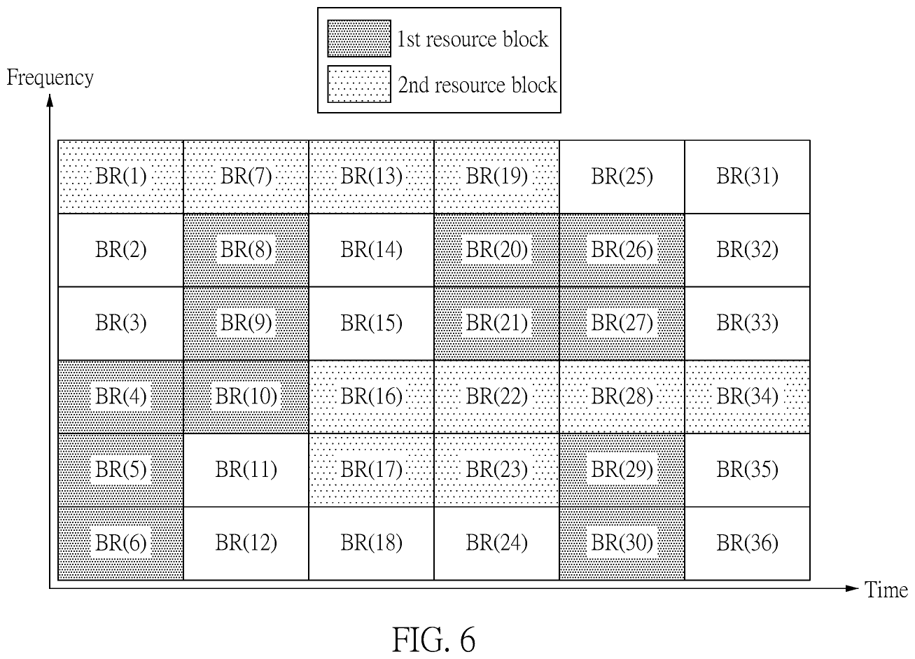

Referring to FIG. 6, FIG. 6 is a schematic diagram showing that resource blocks are allocated to at least one first user equipment in a first application scenario and at least one second user equipment in a second application scenario through a base station according to one embodiment of the present disclosure. As shown in FIG. 6, the base station 11 can allocate first resource blocks including a resource block BR(6), a resource block BR(5), and a resource block BR(4) to the at least one first user equipment in the first application scenario. Since the base station 11 should be able to execute a matching algorithm to determine the first resource blocks that are allocated to the first user equipment 2 of FIG. 1 according to the actual data volume requirement of the first user equipment 2 and the current regulations, details thereof will not be repeated herein.

Similarly, the base station 11 can allocate second resource blocks including a resource block BR(1), a resource block BR(7), and a resource block BR(13) to the at least one second user equipment in the second application scenario. Since the base station 11 should be able to execute a matching algorithm to determine the second resource blocks that are allocated to the second user equipment 3 of FIG. 1 according to the actual data volume requirement of the second user equipment 3 and the current regulations, details thereof will not be repeated herein.

On the other hand, since a transmission quality of each resource block may be changed by other factors, the resource allocation method of the present embodiment can further include step S260 after the base station 11 and the user equipment perform data transmission according to the allocated resource blocks. In step S260, the processing device 13 can continue to obtain and record a (new) quality parameter of each resource block, and can update at least one weight coefficient of the first application scenario suitability index and the second application scenario suitability index according to the (new) quality parameter of each resource block. However, the specific implementation thereof is not limited in the present disclosure. In addition, after updating the at least one weight coefficient in the first application scenario suitability index and the second application scenario suitability index, the processing device 13 can return to re-execute step S220 to step S250, such that the base station 11 can also adjust the allocation in response to changes in the transmission quality of each resource block. In this regard, relevant details are the same as those mentioned previously, and will not be repeated hereinafter.

In conclusion, the resource allocation method and the resource allocation system provided by the embodiments of the present disclosure can calculate the first application scenario suitability index and the second application scenario suitability index of each resource block according to the quality parameters of each resource block, and generate the first ranking sequence and the second ranking sequence for the base station as a basis for allocating the resource blocks, such that the base station can allocate appropriate resource blocks to the user equipment in different application scenarios. Therefore, in the present disclosure, the transmission error rate can be reduced, and efficiency of a resource utilization rate and a transmission rate can be improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A resource allocation method applicable to a base station, wherein the base station is configured to allocate a plurality of resource blocks to at least one first user equipment in a first application scenario and at least one second user equipment in a second application scenario, the resource allocation method comprising:
obtaining a plurality of quality parameters of each of the plurality of resource blocks through a plurality of measurement devices, and calculating a first application scenario suitability index and a second application scenario suitability index for each of the plurality of resource blocks according to the plurality of quality parameters;
generating, according to the first application scenario suitability index of each of the plurality of resource blocks, a first ranking sequence of the plurality of the resource blocks, and generating, according to the second application scenario suitability index of each of the plurality of resource blocks, a second ranking sequence of the plurality of the resource blocks; and
configuring the base station to allocate, according to the first ranking sequence and the second ranking sequence, at least one first resource block and at least one second resource block of the plurality of resource blocks to the at least one first user equipment in the first application scenario and the at least one second user equipment in the second application scenario, respectively.

2. The resource allocation method according to claim 1, wherein the plurality of resource blocks respectively correspond to a plurality of different time intervals or a plurality of different frequency bands.

3. The resource allocation method according to claim 1, wherein the plurality of quality parameters of each of the plurality of resource blocks include a received power, an interference index, and an error rate, and the error rate of each of the plurality of resource blocks is a downlink error rate that is pre-allocated to a connection between a user equipment and the base station by each of the plurality of resource blocks.

4. The resource allocation method according to claim 3, wherein the step of obtaining the plurality of quality parameters of each of the plurality of resource blocks through the plurality of measurement devices includes:
obtaining, by using a reference signal received power (RSRP) measurement device, an RSRP of each of the plurality of resource blocks as the received power of each of the plurality of resource blocks; and
obtaining, by using a bit error rate (BER) measurement device, a BER that is pre-allocated to the connection between the user equipment and the base station by each of the plurality of resource blocks as the error rate of each of the resource blocks.

5. The resource allocation method according to claim 4, wherein the step of obtaining the plurality of quality parameters of each of the plurality of resource blocks through the plurality of measurement devices further includes:
obtaining, by using a received signal strength indication (RSSI) measurement device, an RSSI of each of the plurality of resource blocks, and dividing the RSSI of each of the plurality of resource blocks by the RSRP of each of the plurality of resource blocks to obtain the interference index of each of the plurality of resource blocks.

6. The resource allocation method according to claim 3, wherein the first application scenario is used to meet a transmission need for high reliability and low time delay, and the second application scenario is used to meet a transmission need for high speed and high capacity.

7. The resource allocation method according to claim 6, wherein the first application scenario is ultra-reliable and low latency communications (uRLLC), and the second application scenario is an enhanced mobile broadband (EMBB).

8. The resource allocation method according to claim 6, wherein the first application scenario suitability index of each of the plurality of resource blocks is expressed by a following equation:
$$ω ( i ) = {α}_{1} ⨯ {P}_{rp} ( i ) + {β}_{1} ⨯ \frac{1}{{P}_{inter} ( i )} + {γ}_{1} ⨯ \frac{1}{ER ( i )} ;$$
wherein ω(i) is the first application scenario suitability index of an i-th resource block of the plurality of resource blocks, Pᵣₚ(i) is the received power of the i-th resource block, Pᵢₙₜₑᵣ(i) is the interference index of the i-th resource block, ER(i) is the error rate of the i-th resource block, and α₁, β₁ and γ₁ are respectively a first weight coefficient, a second weight coefficient and a third weight coefficient that Pᵣₚ(i), 1/Pᵢₙₜₑᵣ(i) and 1/ER(i) occupy in ω(i);
wherein a sum of α₁, β₁ and γ₁ is equal to a predetermined constant, and β₁ and γ₁ are greater than α₁.

9. The resource allocation method according to claim 8, wherein the second application scenario suitability index of each of the plurality of resource blocks is expressed by a following equation:
$$ε ( i ) = {α}_{2} ⨯ {P}_{rp} ( i ) + {β}_{2} ⨯ \frac{1}{{P}_{inter} ( i )} + {γ}_{2} ⨯ \frac{1}{ER ( i )} ;$$
wherein ε(i) is the second application scenario suitability index of the i-th resource block of the plurality of resource blocks, and α₂, β₂ and γ₂ are respectively a fourth weight coefficient, a fifth weight coefficient and a sixth weight coefficient that Pᵣₚ (i), 1/Pᵢₙₜₑᵣ(i) and 1/ER(i) occupy in ε(i);
wherein a sum of α₂, β₂ and γ₂ is equal to the predetermined constant, and α₂ is greater than β₂ and γ₂.

10. The resource allocation method according to claim 1, wherein the first ranking sequence is generated by ranking the plurality of resource blocks according to the first application scenario suitability index of each of the plurality of resource blocks from high to low, and the second ranking sequence is generated by ranking the plurality of resource blocks according to the second application scenario suitability index of each of the plurality of resource blocks from high to low.

11. A resource allocation system, comprising:
a base station configured to allocate a plurality of resource blocks to at least one first user equipment in a first application scenario and at least one second user equipment in a second application scenario;
a plurality of measurement devices configured to measure a plurality of quality parameters of each of the plurality of resource blocks; and
a processing device coupled to the base station and the plurality of measurement devices, and configured to perform following steps:
obtaining the plurality of quality parameters of each of the plurality of resource blocks through the plurality of measurement devices, and calculating a first application scenario suitability index and a second application scenario suitability index for each of the plurality of resource blocks according to the plurality of quality parameters;
generating, according to the first application scenario suitability index of each of the plurality of resource blocks, a first ranking sequence of the plurality of the resource blocks, and generating, according to the second application scenario suitability index of each of the plurality of resource blocks, a second ranking sequence of the plurality of the resource blocks; and
configuring the base station to allocate, according to the first ranking sequence and the second ranking sequence, at least one first resource block and at least one second resource block of the plurality of resource blocks to the at least one first user equipment in the first application scenario and the at least one second user equipment in the second application scenario, respectively.

12. The resource allocation system according to claim 11, wherein the plurality of resource blocks respectively correspond to a plurality of different time intervals or a plurality of different frequency bands.

13. The resource allocation system according to claim 11, wherein the plurality of quality parameters of each of the plurality of resource blocks include a received power, an interference index, and an error rate, and the error rate of each of the plurality of resource blocks is a downlink error rate that is pre-allocated to a connection between a user equipment and the base station by each of the plurality of resource blocks.

14. The resource allocation system according to claim 13, wherein a step of obtaining the plurality of quality parameters of each of the plurality of resource blocks through the plurality of measurement devices includes:
obtaining, by using a reference signal received power (RSRP) measurement device, an RSRP of each of the plurality of resource blocks as the received power of each of the plurality of resource blocks; and
obtaining, by using a bit error rate (BER) measurement device, a BER that is pre-allocated to the connection between the user equipment and the base station by each of the plurality of resource blocks as the error rate of each of the resource blocks.

15. The resource allocation system according to claim 14, wherein a step of obtaining the plurality of quality parameters of each of the plurality of resource blocks through the plurality of measurement devices further includes:
obtaining, by using a received signal strength indication (RSSI) measurement device, an RSSI of each of the plurality of resource blocks, and dividing the RSSI of each of the plurality of resource blocks by the RSRP of each of the plurality of resource blocks to obtain the interference index of each of the plurality of resource blocks.

16. The resource allocation system according to claim 13, wherein the first application scenario is used to meet a transmission need for high reliability and low time delay, and the second application scenario is used to meet a transmission need for high speed and high capacity.

17. The resource allocation method according to claim 16, wherein the first application scenario is ultra-reliable and low latency communications (uRLLC), and the second application scenario is an enhanced mobile broadband (EMBB).

18. The resource allocation method according to claim 16, wherein the first application scenario suitability index of each of the plurality of resource blocks is expressed by a following equation:
$$ω ( i ) = {α}_{1} ⨯ {P}_{rp} ( i ) + {β}_{1} ⨯ \frac{1}{{P}_{inter} ( i )} + {γ}_{1} ⨯ \frac{1}{ER ( i )} ;$$
wherein ω(i) is the first application scenario suitability index of an i-th resource block of the plurality of resource blocks, Pᵣₚ(i) is the received power of the i-th resource block, Pᵢₙₜₑᵣ(i) is the interference index of the i-th resource block, ER(i) is the error rate of the i-th resource block, and α₁, β₁ and γ₁ are respectively a first weight coefficient, a second weight coefficient and a third weight coefficient that Pᵣₚ(i), 1/Pᵢₙₜₑᵣ(i) and 1/ER(i) occupy in ω(i);
wherein a sum of α₁, β₁ and γ₁ is equal to a predetermined constant, and β₁ and γ₁ are greater than α₁.

19. The resource allocation system according to claim 18, wherein the second application scenario suitability index of each of the plurality of resource blocks is expressed by a following equation:
$$ε ( i ) = {α}_{2} ⨯ {P}_{rp} ( i ) + {β}_{2} ⨯ \frac{1}{{P}_{inter} ( i )} + {γ}_{2} ⨯ \frac{1}{ER ( i )} ;$$
wherein ε(i) is the second application scenario suitability index of the i-th resource block of the plurality of resource blocks, and α₂, β₂ and γ₂ are respectively a fourth weight coefficient, a fifth weight coefficient and a sixth weight coefficient that Pᵣₚ(i), 1/Pᵢₙₜₑᵣ(i) and 1/ER(i) occupy in ε(i);
wherein a sum of α₂, β₂ and γ₂ is equal to the predetermined constant, and α₂ is greater than β₂ and γ₂.

20. The resource allocation system according to claim 11, wherein the first ranking sequence is generated by ranking the plurality of resource blocks according to the first application scenario suitability index of each of the plurality of resource blocks from high to low, and the second ranking sequence is generated by ranking the plurality of resource blocks according to the second application scenario suitability index of each of the plurality of resource blocks from high to low.
